(19) United States
(12) Patent Application Publication
(10) Pub. No.: US 2025/0188981 A1
(43) Pub. Date: Jun. 12, 2025

(54) SELF-CLINCHING CONSTRUCTION ELEMENT WITH IMPROVED SEALING PERFORMANCE

(71) Applicant: RB&W MANUFACTURING LLC, STREETSBORO, OH (US)

(72) Inventor: Marc Andrew O'Donnell, Burlington (CA)

(21) Appl. No.: 18/531,464

(22) Filed: Dec. 6, 2023

(51) Int. Cl. F16B 37/06

(52) U.S. Cl. CPC F16B 37/068

(57) ABSTRACT

A self-clinching construction element for attachment to a plastically deformable metal substrate includes a body portion with a central axis, the body portion has an annular-shaped surface extending in a direction perpendicular to the central axis. A punch portion is coaxial with the central axis and extends from the body portion such that the annular-shaped surface encircles the punch portion. A plurality of spaced apart lugs axially project outwards from the annular-shaped surface and extending radially outwards from the outer peripheral surface of the punch portion. A lug of the plurality of spaced apart lugs has a maximum width that is less than a maximum width of the punch portion, and a percentage ratio between the maximum width of the lug and the maximum width of the punch portion is in a range of 10% to 22%.

### FIELD OF THE INVENTION

This application relates generally to self-attaching construction elements (e.g., fasteners), and more particularly clinch nuts, studs, and non-threaded elements (e.g., spacers).

### BACKGROUND OF THE INVENTION

Self-attaching construction elements are used in many industries such as, for example, the automotive and appliance industries to secure various components to a metal substrate. During installation, the construction elements must have sufficient rotational resistance (i.e., torque-out resistance) to keep them from rotating relative to the metal substrate. Further, during service, the construction elements must have sufficient push-out resistance to keep them from separating from the metal substrate when external forces such as, for example, vibration or other tensile forces are applied.

Installing (i.e., attaching, joining, etc.) traditional construction elements to conventional substrates (e.g., metal panels) is generally accomplished by forcing the construction element into the substrate (i.e., sandwiching the construction element and the metal panel between a drive mechanism and an anchoring block) such that material of the substrate plastically deforms and conforms to select features and profiles of the construction element. This creates a joint between the construction element and the substrate.

Due to technological advances in the automotive and appliance industry, it is imperative for the joint to provide a sufficient fluid seal between the construction element and the substrate. For example, with reference to vehicles (and more particularly electric vehicles), it is important to hinder/prevent ingress of liquid/moisture within the vehicle compartment due to the corrosive effects as well as degradation of electrical systems if liquid/moisture is introduced thereto. As such, some automobile manufactures now set forth an air decay requirement, wherein a construction element must hold a loss of pressure (per construction element) that does not exceed 0.1 cm³/min.

Accordingly, there is a need in the art for improved construction elements which can be reliably and consistently attached to various substrates, wherein the attachment of the construction element to the substrate yields sufficient torque-out and push-out strength, as well as complying with the above-noted air decay requirement.

### BRIEF SUMMARY OF THE INVENTION

In accordance with one aspect, there is provided a self-clinching construction element for attachment to a plastically deformable metal substrate. The self-clinching construction element includes a body portion with a central axis, the body portion including an annular-shaped surface extending in a direction perpendicular to the central axis. A punch portion is coaxial with the central axis and extends from the body portion such that the annular-shaped surface encircles the punch portion. Further, the punch portion includes an outer peripheral surface extending in a direction of the central axis. A plurality of spaced apart lugs axially project outwards from the annular-shaped surface and extend radially outwards from the outer peripheral surface of the punch portion. The plurality of spaced apart lugs collectively encircle the punch portion. A lug of the plurality of spaced apart lugs has a maximum width that is less than a maximum width of the punch portion. Further, a percentage ratio between the maximum width of the lug and the maximum width of the punch portion is in a range of 10% to 22%.

In accordance with another aspect, there is provided a self-clinching construction element for attachment to a plastically deformable metal substrate. The self-clinching construction element includes a body portion with a central axis. The body portion includes an annular-shaped surface extending in a direction perpendicular to the central axis and an outer peripheral surface extending in a direction of the central axis. A punch portion is provided and is coaxial with the central axis and extends from the body portion such that the annular-shaped surface encircles the punch portion. The punch portion includes an outer peripheral surface that extends in the direction of the central axis and that has a cylindrical profile. Further, a plurality of spaced apart lugs axially project outwards from the annular-shaped surface and extend radially outwards from the outer peripheral surface of the punch portion. The plurality of spaced apart lugs collectively encircle the punch portion.

Moreover, a lug of the plurality of spaced apart lugs has a maximum width that is smaller than a maximum diameter of the punch portion. Further, a percentage ratio between the maximum width of the lug and the maximum diameter of the punch portion is in a range of 10% to 22%. Additionally, the annular-shaped surface of the body portion terminates at a peripheral edge which is coterminous with the outer peripheral surface of the body portion. Further still, the lug has opposite, first and second end portions, wherein the first end portion is disposed adjacent to the outer peripheral surface of the punch portion, and wherein the second end portion is provided at the peripheral edge. Moreover, a width of the lug increases with distance from the outer peripheral surface of the punch portion, and the maximum width of the lug is taken at the second end portion.

### BRIEF DESCRIPTION OF THE DRAWINGS

FIG. 1 is a perspective view of a construction element;

FIG. 2 is a side view of the construction element depicted in FIG. 1;

FIG. 3 is a top view of the construction element depicted in FIG. 1;

FIG. 4 is a sectional view of the construction element taken along the line 4-4 in FIG. 3;

FIG. 5 is an enlarged view of detail area “5” depicted in FIG. 4;

FIG. 6 is an enlarged view of detail area “6” depicted in FIG. 4;

FIG. 7 is a perspective view of a stud including a clinch mounting portion as shown in FIG. 1;

FIG. 8 is a perspective view of a prior art construction element;

FIG. 9 is a top view of the prior art construction element depicted in FIG. 8;

FIG. 10 is a graph depicting air decay test results associated with a conventional construction element, such as the prior art construction element depicted in FIG. 8; and

FIG. 11 is a graph depicting air decay test results associated with a new construction element, such as the construction element depicted in FIG. 1.

### DESCRIPTION OF EXAMPLE EMBODIMENTS

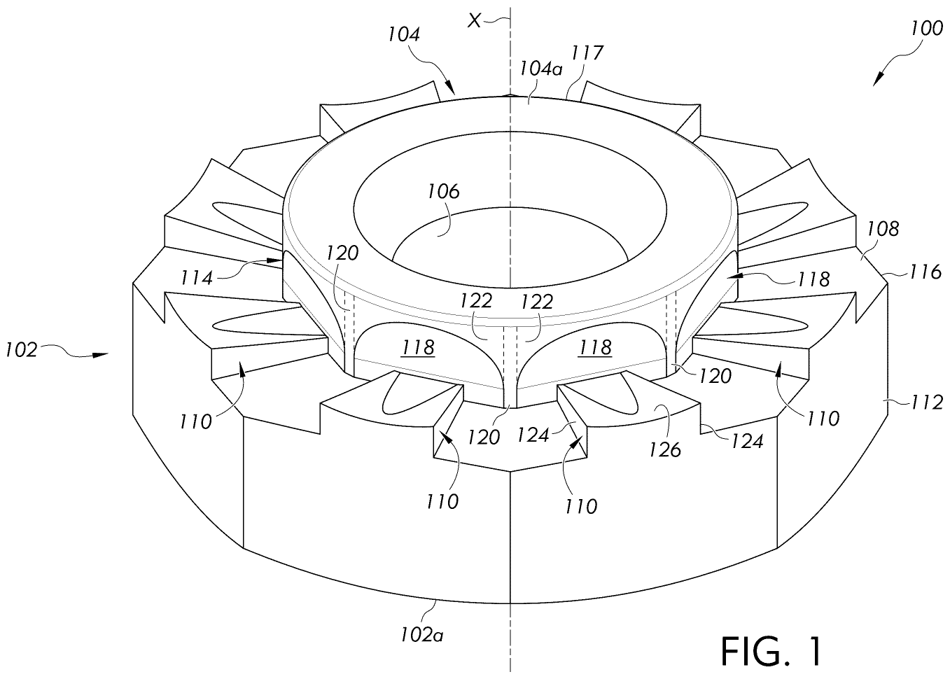

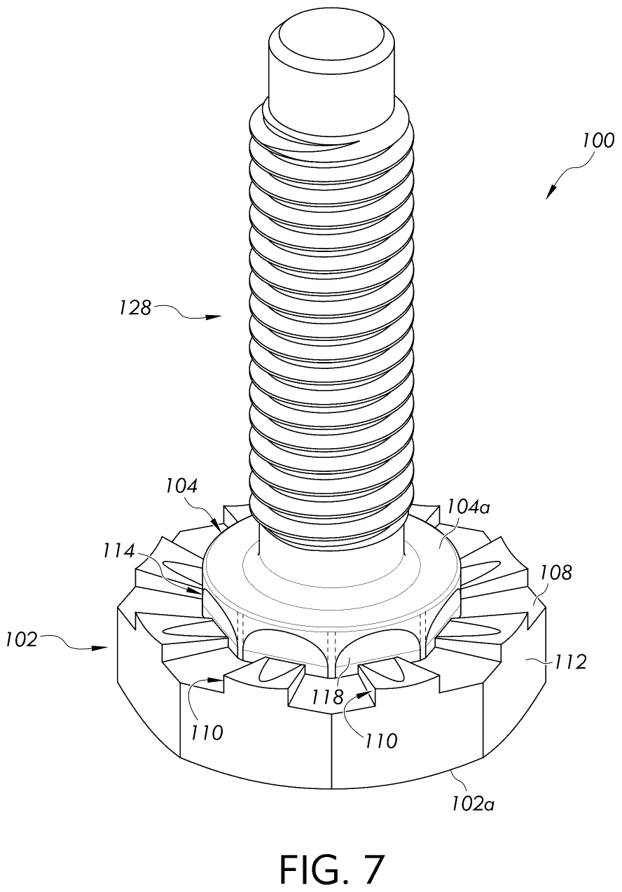

It is to be appreciated that the following description includes many features which can be utilized in various combinations that may include all or less than all of the features. All such combinations of features are intended to come within the scope of this application. Referring now to the drawings, FIG. 1 depicts a construction element 100, which includes fasteners, for attachment to a plastically deformable metal substrate (e.g., a plate, a panel, a hollow cylinder, etc.). Specifically, the construction element 100 described herein is attachable to both conventional metal substrates (e.g., flat, relatively thin metal panels) and non-conventional metal substrates (e.g., hollow-metal tubes), and provides sufficient rotational and push-out resistances. The construction element 100 may be a self-clinching construction element that, during installation to the metal substrate, clinches and attaches to a pre-made hole formed in the metal substrate having a thickness of 1 mm or greater. Optionally, the construction element 100 is a self-piercing and self-clinching construction element that, during installation, both pierces an aperture in the metal substrate and clinches itself thereto. While the illustrated embodiment depicts the construction element 100 as a spacer, sleeve, etc. (i.e., a non-threaded construction element), other self-clinching construction elements such as, for example, self-piercing and/or self-clinching studs (depicted in FIG. 7, and briefly discussed below) and self-piercing and/or self-clinching nuts are within the scope of the present invention. For brevity, a majority of the below-description will be made with respect to an embodiment depicting the construction element 100 as a self-clinching spacer (i.e., a non-threaded construction element), with the understanding that this disclosure likewise applies to self-piercing and/or self-clinching studs and/or nuts, as well as any other types of construction elements.

With reference to FIG. 1, the construction element 100 has a body portion 102 and a multi-purpose pilot or punch portion 104 extending from one end of the body portion 102. A through-hole or bore 106 axially extends through both the body portion 102 and the punch portion 104. While the bore 106 is shown as being a simple through-hole (i.e., having a smooth, uninterrupted circumferential wall), it is contemplated that the bore 106 can be threaded (to yield a self-clinching nut) such that a mating, threaded fastener (e.g., bolt, screw, etc.) can be inserted in the threaded bore for attachment thereto. In another example, where the construction element 100 is a self-piercing and self-clinching stud such as shown in FIG. 7, the punch portion 104 can be solid and contain no through-hole; instead, a threaded or non-threaded stud can extend outwards from the opposite side of the body portion 102, as described below.

In yet another example where the construction element 100 is a self-clinching spacer, upon installation of the construction element 100 to a plastically deformable metal substrate, a fastener (e.g., a bolt, threaded screw, etc.) can be inserted into the bore 106 such that a spaced distance is provided between either a head of the fastener and the metal substrate, or a corresponding nut (configured to be attached to the bolt, screw, etc.) and the metal substrate. That is, the construction element 100 provides a predetermined space between two distinct objects (i.e., the metal substrate and a separate fastener).

As further shown, the body portion 102 and the punch portion 104 are coaxial with a central axis ‘X.’ With reference to FIGS. 1-4, the body portion 102 extends to a bottom or first end surface 102a of the construction element 100, corresponding to one axial extremity of the constructional element 100. The first end surface 102a of the construction element 100 is shown as being substantially perpendicular to the central axis “X,” and having an optional chamfer at a radially, outer periphery thereof. However, the first end surface 102a may have other geometric configurations; for example, the first end surface 102a may be inclined or declined with respect to the central axis “X.” Said differently, the first end surface 102a may gradually converge radially inwards or diverge radially outwards with respect to an installation direction of the construction element 100. As is further shown, the punch portion 104 extends to a top or second end surface 104a of the construction element 100, corresponding to the other axial extremity of the construction element 100. The second end surface 104a of the construction element 100 is likewise depicted as being substantially perpendicular to the central axis “X,” however, the second end surface 104a could alternatively be angled, as described above with respect to the first end surface 102a.

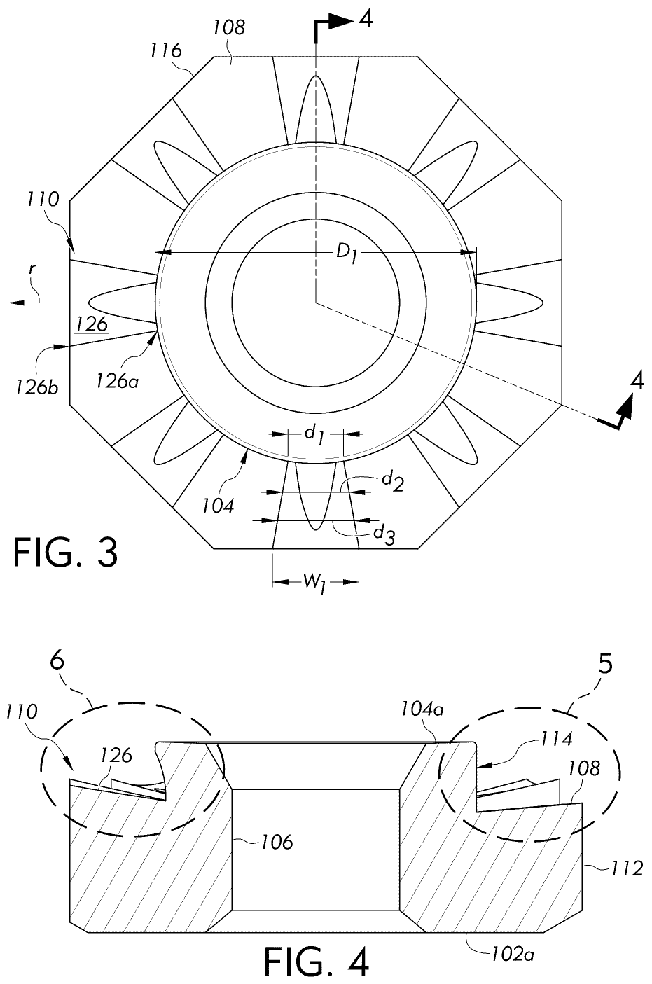

The punch portion 104 is radially smaller than the body portion 102 such that the body portion 102 includes a generally annular-shaped surface 108 encircling the punch portion 104. That is, the punch portion 104 extends from the body portion 102 in a direction of the central axis ‘X,’ and is positioned such that the annular-shaped surface 108 encircles the punch portion 104. The annular-shaped surface 108 extends in a direction perpendicular to the central axis (i.e., extending in a radial direction ‘r’ of the construction element 100, as shown in FIG. 3) and is configured to engage the metal substrate to which the construction element 100 is to be attached to.

As further shown, the construction element 100 includes a plurality of spaced apart lugs 110 that collectively encircle the punch portion 104. As will be further discussed below, each of the lugs 110 axially projects outward from the annular-shaped surface 108 in a direction opposite to the first end surface 102a of the construction element 100. In one embodiment, as shown, the plurality of lugs 110 are equally spaced apart, one from the other, and all have the same configuration. Alternatively, the plurality of lugs 110 can be unequally spaced apart about the punch portion 104, one from the other, and/or can have varying configurations.

With respect to FIGS. 1 and 4, the body portion 102 and punch portion 104 include outer peripheral surfaces 112, 114, respectively, that extend in a direction of the central axis “X.” In one embodiment, the outer peripheral surface 112 of the body portion 102 is planar and parallel with respect to the central axis “X” to provide a polygonal shape having flat sides which can be readily used by machine tools. Alternatively, the outer peripheral surface 112 of the body portion 102 may be curved with a convex or concave shape and/or non-parallel with respect to the central axis “X.” In the shown example, the outer peripheral surface 112 of the body portion 102 is polygonal-shaped and is formed by a plurality of faces. Specifically, the plurality of faces all have the same dimensions (i.e., height and width) such that the outer peripheral surface 112 of the body portion 102 is formed by eight faces (as best shown in FIG. 3). Alternatively, a total of four to twelve faces may form the outer peripheral surface 112 of the body portion 102. It is further noted that the outer peripheral surface 112 of the body portion 102 need not be polygonal-shaped, and may have other geometric configurations (e.g., cylindrical). The height (i.e., the axial dimension) and width (i.e., the radial dimension) of the body portion 102 are selected to provide sufficient engagement between the bore 106 and a mating member (e.g., a bolt). For example, where the construction element 100 has a threaded bore 106, the dimensions of the body portion 102 are chosen such that a mating externally threaded member may consistently engage with and break from the threaded bore 106, without stripping the threads. Where the construction element 100 has a self-clinching stud, the height and width of the body portion 102 can be likewise selected to provide sufficient strength for the stud and any intended mating fasteners.

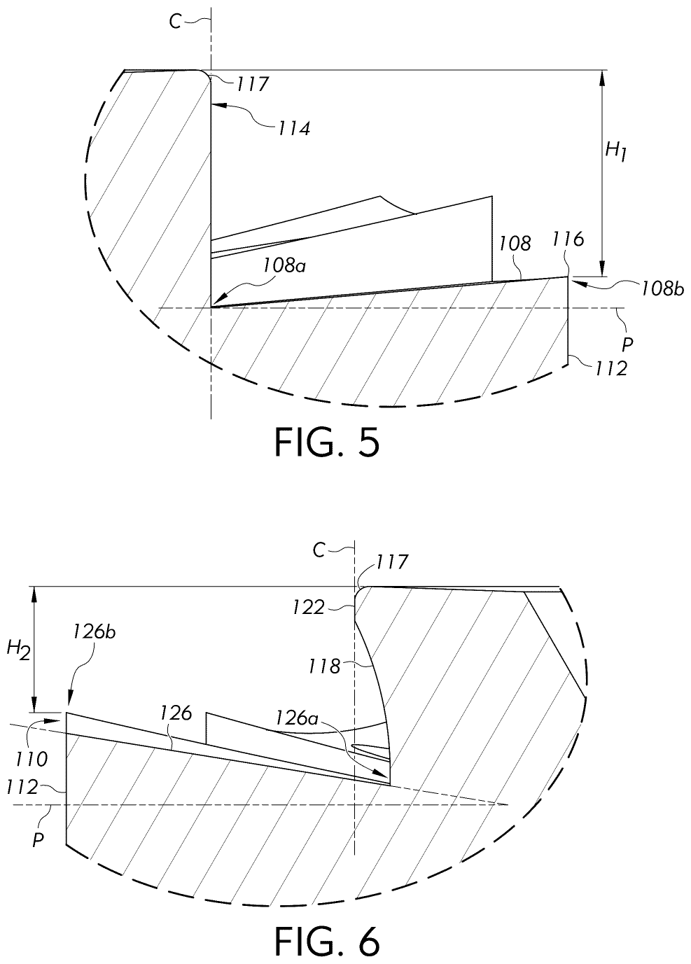

With reference to FIGS. 3 and 5, FIG. 5 being an enlarged detail view of an encircled area of the construction element 100 depicted in FIG. 4, the annular-shaped surface 108 has a first end portion 108a and a second end portion 108b. The first end portion 108a is positioned adjacent the outer peripheral surface 114 of the punch portion 104 and the second end portion 108b is positioned radially outwards therefrom. In one example (as shown), the second end portion 108b of the annular-shaped surface 108 terminates at a peripheral edge 116 thereof and is coterminous with the outer peripheral surface 112 of the body portion 102. Alternatively, the second end portion 108b need not be coterminous with the outer peripheral surface 112 of the body portion 102. As further shown, the annular-shaped surface 108 is angled with respect to an imaginary horizontal plane “P.” Specifically, the imaginary horizontal plane “P” is configured such that the central axis “X” is normal thereto. Additionally, the imaginary horizontal plane “P” is coterminous with the first end portion 108a of the annular-shaped surface 108. That is, in the depicted example, the imaginary horizontal plane “P” is coterminous with an intersection point between the first end portion 108a of the annular-shaped surface 108 and the outer peripheral surface 114 of the punch portion 104.

Notably, in the depicted example, the annular-shaped surface 108 is planar, and continuously inclines in the radially (outward) direction. More specifically, as the annular-shaped surface 108 radially extends from the outer peripheral surface 114 (i.e., in a direction from the first end portion 108a to the second end portion 108b), a (vertical) distance between the annular-shaped surface 108 and the imaginary horizontal plane “P” increases. Notably, the highest point of the annular-shaped surface 108 (i.e., at the second end portion 108b thereof) is provided at a first axial distance “H₁” from a distal peripheral edge 117 of the punch portion 104 (described further below). In other words, the first axial distance “H₁” represents a minimum distance (in a direction parallel to the central axis “X”) between the distal peripheral edge 117 of the punch portion 104 and the annular-shaped surface 108.

In an alternative example, the annular-shaped surface 108 need not be planar. For example, the annular-shaped surface 108 may be convex-or concave-shaped in cross-section. Additionally, in another alternative example, the annular-shaped surface 108 need not continuously incline from the first end portion 108a to the second end portion 108b. For example, the annular-shape surface 108 may include a section between the first and second end portions 108a, 108b that is parallel to the imaginary horizontal plane “P” or that declines relative to the imaginary horizontal plane “P.”

Moving back to FIG. 1, the outer peripheral surface 114 of the punch portion 104 extends in the direction of the central axis “X” between the annular-shaped surface 108 of the body portion 102 and the distal peripheral edge 117 of the punch portion 104 (i.e., an edge where the second end surface 104a and the outer peripheral surface 114 of the punch portion 104 intersect). Further, the outer peripheral surface 114 of the punch portion 104 has a cylindrical profile. That is, the outer peripheral surface 114 of the punch portion 104 preferably has radiused corners which collectively yield a rounded surface. Said differently, the outer peripheral surface 114 preferably has no sharp edges that extend beyond an imaginary circumferential plane “C” (shown in FIG. 6) that bounds (i.e., encircles) the outer peripheral surface 114 of the punch portion 104.

The outer peripheral surface 114 of the punch portion 104 having a cylindrical profile with no sharp edges greatly reduces or even eliminates the potential for imperfections (e.g., cracking) to form in the construction element 100 and/or the metal panel during installation. Specifically, because metal panels are now manufactured from relatively stronger, harder materials (e.g., hot-formed steel), the substrate does not flow (i.e., plastically deform) easily during installation. As such, sharp or pointed edges on the outer peripheral surface 114 of the punch portion 104 are susceptible to cracking due to the forces imparted thereon during installation. Accordingly, the construction element 100 described herein, having no sharp or pointed edges on the outer peripheral surface 114 of the punch portion 104, is removed from the above-noted problem and is less likely to yield a defective finished product.

As further shown, a plurality of spaced apart cutouts 118 are formed in the outer peripheral surface 114 of the punch portion 104 and are arranged so as to collectively encircle the punch portion 104. In one embodiment, the plurality of cutouts 118 are equally spaced apart, one from the other, and all have the same configuration. Specifically, each cutout 118 has a concaved surface with respect to the outer peripheral surface 114 of the punch portion 104. Alternatively, the plurality of cutouts 118 can have varying spacing and/or configurations, such as where only one cutout 118 has a concaved surface.

The outer peripheral surface 114 of the punch portion 104 further comprises a plurality of spaced apart column portions 120 (shown in FIG. 1 in dashed lines) wherein each column portion 120 is defined as an area of the cylindrically profiled outer peripheral surface 114 of the punch portion 104 between a pair of adjacently spaced cutouts 118. The plurality of spaced apart column portions 120 collectively encircle the punch portion 104, and each column portion 120 extends from the annular-shaped surface 108 to the distal peripheral edge 117 of the outer peripheral surface 114 of the punch portion 104. Specifically, each column portion 120 is disposed between and spaces apart a respective pair of adjacently spaced apart cutouts 118.

As mentioned above, in one embodiment, the plurality of cutouts 118 are shown as being equally spaced apart, one from the other. Specifically, it is the plurality of column portions 120 that provide the equal spacing between the plurality of cutouts 118. As such, the plurality of column portions 120 are likewise equally spaced, one from the other. As further mentioned above, the outer peripheral surface 114 of the punch portion 104 has a cylindrical profile with no sharp edges; this is a result of the column portions 120 being disposed between and spacing apart a respective pair of adjacently spaced apart cutouts 118. That is, if a pair of cutouts 118 were disposed directly adjacent one another, with nothing therebetween, there would be no surface having a cylindrical profile provided between the pair of adjacent cutouts 118, thus resulting in the formation of a sharp edge.

Still further, in one embodiment, the outer peripheral surface 114 of the punch portion 104 comprises a plurality of bridge portions 122 that are spaced apart, one from the other, and which collectively encircle the punch portion 104. Specifically, each bridge portion 122 is defined as an area of the cylindrically profiled outer peripheral surface 114 of the punch portion 104 disposed between a pair of adjacently spaced column portions 120. Further, each bridge portion 122 is positioned axially between the distal peripheral edge 117 of the outer peripheral surface 114 of the punch portion 104 and the cutout 118 which is bounded by the pair of adjacently spaced column portions 120. In this manner, each bridge portion 122 connects a respective pair of adjacently spaced apart column portions 120.

As further shown in FIG. 1 and as briefly mentioned above, each of the lugs 110 axially projects outwards from the annular-shaped surface 108 of the body portion 102 and extends radially outwards from the outer peripheral surface 114 of the punch portion 104. Additionally, each lug 110 is radially aligned with one of the cutouts 118. Moreover, the total number of radially aligned lugs 110 and cutouts 118 can depend on the total number of faces of the outer peripheral surface 112 of the body portion 102 and can each be radially aligned therewith. That is, for example, in FIGS. 1 and 3, the construction element 100 comprises a total of eight faces that collectively construct the outer peripheral surface 112 of the body portion 102. In this manner, the construction element 100 further comprises a total of eight lugs 110 and cutouts 118, each, that are radially aligned with a respective one of the eight faces that makes up the outer peripheral surface 112 of the body portion 102. Alternatively, the total number of lugs 110 can be different than the total number of cutouts 118 and/or faces of the outer peripheral surface 112 of the body portion 102. Moreover, the lugs 110, cutouts 118 and/or the faces of the outer peripheral surface 112 of the body portion 102 need not be radially aligned. For example, one lug 110 could be radially aligned with an edge formed between a pair of adjacent faces of the outer peripheral surface 112 of the body portion 102.

All of the components of the above-discussed construction element 100, specifically the body portion 102, the punch portion 104, and the lugs 110, are formed integrally with respect to one another. That is, the body portion 102, the punch portion 104 and the lugs 110 are all formed from the same stock material. For example, the construction element 100 can be manufactured from treated steal, and in one example specifically from 10B21 steel. However, the material selection is not limited to 10B21 steel, and other suitable materials may be used. Furthermore, it is preferable for the material of the construction element 100 to have a hardness greater than that of the substrate (e.g., metal panel) to which it is to be attached to.

Where the construction element 100 is a self-clinching stud, the stud would likewise be integrally formed of the same material. For example, with reference to FIG. 7, the construction element 100 may be a self-piercing and/or self-clinching stud. In such a configuration, the construction element 100 includes the body portion 102 and the punch portion 104. A shank 128 extends outwards from the second end surface 104a of the construction element 100 along the central axis In other examples, the shank 128 may extend outwards from the first end surface 102a of the construction element 100 along the central axis “X.” As shown, at least a portion of the shank 128 may be threaded. Alternatively, the shank 128 may not be threaded.

The geometric shape of a single lug 110 will now be discussed with the understanding that the below-disclosure likewise applies to the other lugs. With reference to FIG. 1, the lug 110 includes a pair of upstanding side-walls 124 and a contact face 126. More specifically, the contact face 126 extends between the pair of side-walls 124 (i.e., in a circumferential direction of the construction element 100) and extends in the radial direction ‘r.’ As depicted in FIGS. 3-4, the contact face 126 has opposite, first and second (radial) end portions 126a, 126b. The first end portion 126a is disposed adjacent the outer peripheral surface 114 of the punch portion, and more particularly, extends (radially) outwards from a corresponding cutout 118 formed in the outer peripheral surface 114. In this manner, the first end portion 126a of the contact face 126 (i.e., an end portion of the lug 110) is formed with the cutout 118 that said lug 110 is radially aligned with. Additionally, the second end portion 126b is located at the peripheral edge 116 of the annular-shaped surface 108 and possibly coterminous with the outer peripheral surface 112 of the body portion 102.

Notably, in the depicted example, the lug 110 does not have a uniform width between the first and second end portions 126a, 126b of the contact face 126. Rather, as best shown in FIG. 3, a width of the lug 110 continuously increases with distance from the outer peripheral surface 114 of the punch portion 104. More specifically, a first distance di spans linearly between the pair of side-walls 124 at a location of the lug 110 adjacent the outer peripheral surface 114 of the punch portion 104. The first distance d₁ is less than any other linear distance (e.g., d₂ or d₃) between the pair of side-walls 124 taken radially outwards therefrom (i.e., in the radial direction ‘r’ towards the second end portion 126b of the contact face 126). Of note, the lug 110 need not have a varying width, as described above. For example, the lug 110 may have a uniform width between the first and second end portions 126a, 126b of the contact face 126. In another alternative example (not shown), the lug 110 may have a uniform width at a discrete section thereof that is either interposed between or disposed adjacent other discrete section(s) which have a varying width.

Moving on to FIG. 6, the contact face 126 of the lug 110 has a concave-shaped profile. That is, the contact face is curved (i.e., rounded laterally, side-to-side between the pair of side-walls 124) with respect to an imaginary axis extending in the radial direction “r” of the construction element 100. In other examples, the contact face can have a “V” or “U”-shaped geometry. Preferably, the lowest point of the contact face 126 (relative to the imaginary horizontal plane “P”) is at its midpoint, although other geometries are contemplated. In one example, the contact face 126 is configured to engage the substrate (e.g., metal panel) to which the construction element 100 is to be attached to, and inclines, relative to the imaginary horizontal plane “P,” in the radially outwards direction of the construction element 100. As shown in the depicted example, the contact face 126 inclines in a continuous manner relative to the imaginary horizontal plane “P,” in the radially outwards direction of the construction element 100.

As further shown, the highest point of the lug 110 (i.e., at the second end portion 126b thereof) is provided at a second axial distance “H₂” from the distal peripheral edge 117 of the punch portion 104. In other words, the second axial distance “H₂” represents a minimum distance (in the direction parallel to the central axis “X”) between the distal peripheral edge 117 of the punch portion 104 and the lug 110. Notably, the second axial distance “H₂” is less than the first axial distance “H₁,” described above. Additionally, a ratio between the second axial distance “H₂” and the first axial distance “H₁” (expressed as a percentage) does not exceed 50%.

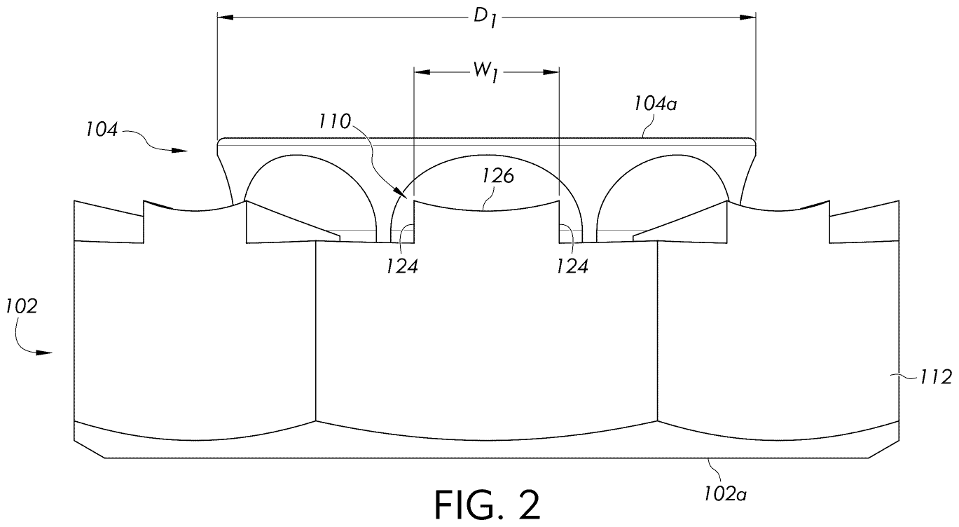

With reference to FIGS. 2-3, a maximum width “W₁” of the lug 110 is less than a maximum width “D₁” of the punch portion 104. Notably, the above-noted widths are linear measurements taken between outer extremities of their respective structures, in a top view of the construction element 100 (e.g., as shown in FIG. 3). As previously mentioned above, in the depicted example, the outer peripheral surface 114 of the punch portion 104 has a cylindrical profile. Accordingly, the maximum width “D₁” of the punch portion 104 corresponds to a maximum diameter of the punch portion 104. More specifically, the maximum width “D₁” of the punch portion 104 corresponds to an outer-most (maximum) diameter of the punch portion 104. For simplicity, the maximum width of the punch portion 104 will be referred to below as the maximum diameter “D₁” of the punch portion 104.

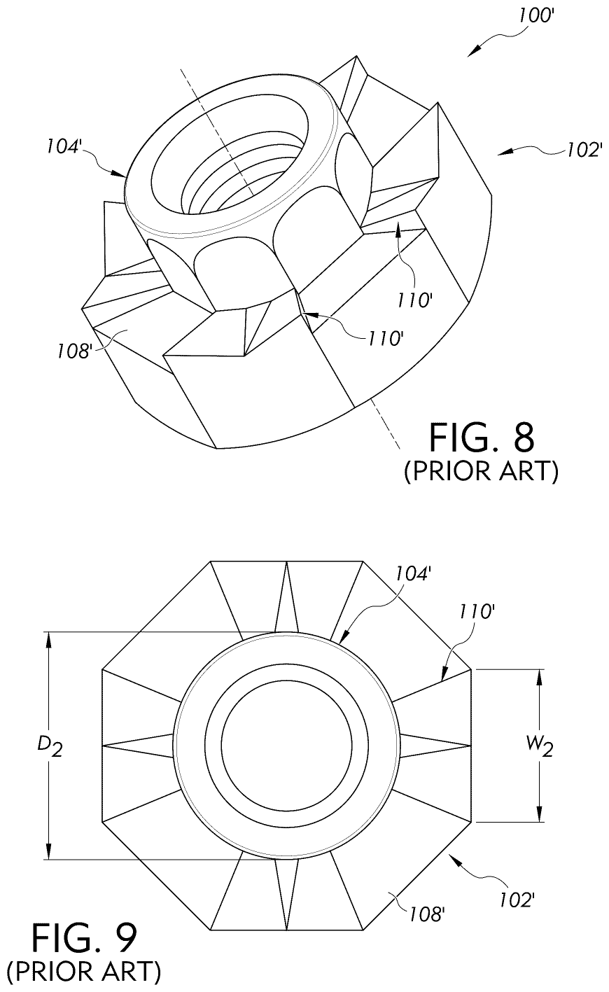

In the depicted example, the maximum width “W₁” of the lug 110 is provided at the second end portion 126b of the contact face 126 (i.e., at an end of the lug 110 distal from the punch portion 104). However, in other examples, the maximum width “W₁” of the lug 110 may be at other radial locations. Of note, such dimensional differences are conventional. Specifically, with reference to FIGS. 8-9, a conventional construction element 100′ is shown and includes a body portion 102′ and a punch portion 104′. A plurality of lugs 110′ project (axially) outwards from an annular-shaped surface 108′ encircling the punch portion 104′. As specifically shown in FIG. 9, a maximum width “W₂” of one of the lugs 110′ is less than a maximum diameter “D₂” of the punch portion 104′.

A crucial difference between the configuration of the new construction element 100 (as described herein) and those of old (e.g., the conventional element 100′) is the dimensional ratio between the maximum width “W₁” of the lug 110 and the maximum diameter “D₁” of the punch portion 104. For simplicity, the below-noted ratios will be expressed as percentages—i.e., the maximum width “W₁” of the lug 110 divided by the maximum diameter “D₁” of the punch portion 104, multiplied by one hundred.

A comparison will now be made with respect to the new construction element 100 (as described above) and a conventional construction element (such as the construction element 100′ depicted in FIGS. 8-9) with respect to experimental data obtained by the inventors. Of note, the data compiled and set forth below is with respect to new and conventional constructions elements having the same general dimensions (except for the above-mentioned dimensional ratio).

With respect to the conventional construction element 100′ (and others not discussed herein), a ratio between the maximum width “W₂” of the lug 110′ and the maximum diameter “D₂” of the punch portion 104 is generally greater than or equal to 28%. During installation, this yields a joint between the conventional construction element 100′ and the substrate that provides sufficient torque-out and push-out strength. However, that dimensional ratio (i.e., between the maximum width “W₂” of the lug 110′ and the maximum diameter “D₂” of the punch portion 104) produces a joint that is susceptible to air decay “leaking.” That is, the joint between the conventional construction element 100′ and the substrate provides a “leak” path, permitting ingress of moisture and/or liquid. As expressed above, this “leak” path can have detrimental effects for the overall product. For example, in the automotive industry, such “leak” paths can lead to corrosion of the substrate at the joint, reducing its torque-out and/or push-out strength, potentially to the point of failure.

The new construction element 100 (discussed above) has a ratio (i.e., between the maximum width “W₁” of the lug 110 and the maximum diameter “D₁” of the punch portion 104) within a range of 10% to 22%. In comparison to the above-noted ratio of the conventional construction element 100′, this new ratio range of 10% to 22% amounts to about a 42% reduction as compared to the conventional construction element 100′. It has been determined that this ratio reduction is directly correlated to a vast improvement in resistance to air decay (or the joint's susceptibleness to leaking). Indeed, the above-noted changes in the new construction element 100 (with respect to the conventional construction element 100′) yield substantially similar torque-out and push-out strength, while providing a superior sealed joint.

TABLE 1

| | Torque-Out Test | Push-Out Test | Air Decay Test |
|---|---|---|---|
| Trial # | Results (Nm) | Results (kN) | Results (cm³/min) |
| 1 | 50.2 | 3.39 | 0.100 |
| 2 | 47.5 | 3.71 | 0.101 |
| 3 | 47.5 | 3.79 | 0.102 |
| 4 | 48.8 | 3.96 | 0.090 |
| 5 | 51.5 | 3.88 | 0.080 |
| 6 | 52.9 | 3.51 | 0.090 |
| 7 | 51.5 | 3.59 | 0.095 |
| 8 | 50.2 | 3.47 | 0.088 |
| 9 | 50.2 | 3.25 | 0.101 |
| 10 | 48.8 | 3.39 | 0.103 |
| 11 | 51.5 | 3.41 | 0.091 |
| 12 | 51.5 | 3.32 | 0.094 |
| 13 | 51.5 | 3.66 | 0.086 |
| 14 | 50.2 | 3.26 | 0.085 |
| 15 | 51.5 | 3.45 | 0.096 |
| 16 | 50.2 | 3.43 | 0.100 |
| 17 | 52.9 | 3.57 | 0.087 |
| 18 | 48.8 | 3.58 | 0.110 |
| 19 | 46.1 | 3.35 | 0.100 |
| 20 | 52.9 | 3.67 | 0.092 |
| 21 | 51.5 | 3.50 | 0.087 |
| 22 | 48.8 | 3.99 | 0.102 |
| 23 | 47.5 | 4.05 | 0.081 |
| 24 | 52.9 | 3.47 | 0.087 |
| 25 | 47.5 | 3.23 | 0.089 |
| Mean | 50.1 | 3.60 | 0.094 |
| Std Dev | 2.0 | 0.20 | 0.008 |
| Mean − 3SD | 44.2 | 2.90 | 0.070 |

With reference to Table 1 (shown above), experimental data is shown for a conventional construction element (i.e., the conventional construction element 100′ having a ratio roughly equal to 28%) underwent various testing to determine its torque-out, push-out, and air-decay performance. As shown, the conventional construction element 100′ has an average torque-out specification of 50.1 Nm, an average push-out specification of 3.6 kN, and an average air decay specification of 0.094 cm³/min. While the above-noted torque-out and push-out specifications provide satisfactory torque-out and push-out strength, the results of the air decay specification are concerning. Specifically, while the resulting average value of the air decay testing (i.e., 0.094 cm³/min) falls below the (required) standard of 0.1 cm³/min (set forth by auto-manufacturers), multiple test results exceeded that standard. More specifically, out of the twenty-five trials, the conventional construction element 100′ exceeded the standard 0.1 cm³/min a total of six times. Said differently, 24% of the trials did not meet the standard set forth by auto-manufacturers.

In comparison, with reference to Table 2 (shown below), experimental data is shown for the new construction element 100 (i.e., having a ratio within a range of 10% to 22%) has similar (i.e., satisfactory) torque-out and push-out performance with respect to the conventional construction element 100′, however, its air decay performance has greatly improved. More specifically, the average value of the air decay testing for the new construction element resulted in 0.00 cm³/min. Indeed, none of the trials exceeded, or even came close to meeting, the 0.1 cm³/min standard.

TABLE 2

| | Torque-Out Test | Push-Out Test | Air Decay Test |
|---|---|---|---|
| Trial # | Results (Nm) | Results (kN) | Results (cm³/min) |
| 1 | 46.1 | 3.19 | 0.000 |
| 2 | 44.7 | 2.39 | 0.000 |
| 3 | 46.1 | 3.09 | 0.000 |
| 4 | 46.1 | 3.17 | 0.000 |
| 5 | 46.1 | 3.52 | 0.000 |
| 6 | 43.4 | 2.98 | 0.002 |
| 7 | 46.1 | 2.88 | 0.000 |
| 8 | 46.1 | 3.07 | 0.001 |
| 9 | 46.1 | 3.26 | 0.001 |
| 10 | 43.4 | 3.12 | 0.001 |
| 11 | 44.7 | 2.63 | 0.001 |
| 12 | 46.1 | 2.60 | 0.000 |
| 13 | 43.4 | 3.03 | 0.001 |
| 14 | 47.5 | 3.33 | 0.001 |
| 15 | 44.7 | 2.86 | 0.003 |
| 16 | 40.7 | 3.45 | 0.000 |
| 17 | 44.7 | 3.14 | 0.000 |
| 18 | 47.5 | 3.06 | 0.000 |
| 19 | 43.4 | 2.82 | 0.000 |
| 20 | 46.1 | 3.54 | 0.000 |
| 21 | 44.7 | 3.14 | 0.000 |
| 22 | 44.7 | 3.14 | 0.000 |
| 23 | 42 | 3.43 | 0.002 |
| 24 | 43.4 | 2.84 | 0.000 |
| 25 | 43.4 | 3.01 | 0.000 |
| 26 | 47.5 | 3.21 | 0.000 |
| 27 | 44.7 | 3.04 | 0.000 |
| 28 | 44.7 | 2.99 | 0.000 |
| 29 | 47.5 | 3.21 | 0.001 |
| 30 | 47.5 | 2.68 | 0.001 |
| Mean | 45.1 | 3.10 | 0.000 |
| Std Dev | 1.7 | 0.30 | 0.001 |
| Mean − 3SD | 40.0 | 2.20 | 0.003 |

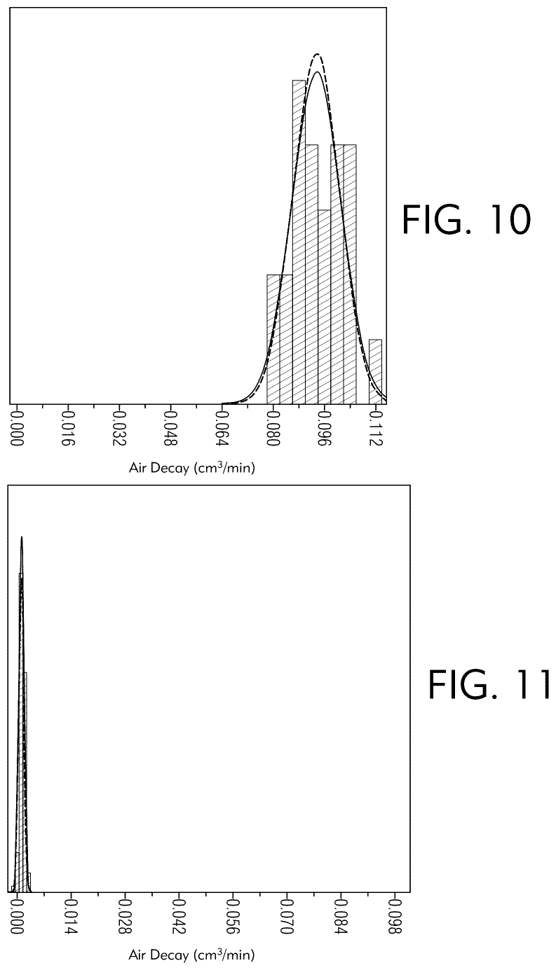

To further evidence how vast this improvement is, the testing results for each of the conventional and new construction elements (i.e., as represented in Table 1 and Table 2, respectively) have been plotted in respective bar graphs. With respect to FIG. 10, the results of the conventional construction element 100′ are shown. As is clear, all of the results are above 0.080 cm³/min, a majority of which approach the 0.1 cm³/min standard, with multiple results exceeding it. In contrast, with reference to FIG. 11 (depicting the results of the new construction element 100), all of the results are less than 0.007 cm³/min. Indeed, in comparison to the graph shown in FIG. 10 (which has a substantially similar scale on its X-axis in cm³/min), the resulting bars in FIG. 11 have been shifted completely to the left. This increase in air-decay performance (i.e., a reduction in loss of pressure per construction element) is a direct result of the (roughly) 42% reduction in the above-noted dimensional ratio. Said differently, by bounding the ratio (i.e., between the maximum width “W₁” of the lug 110 and the maximum diameter “D₁” of the punch portion 104) within a range of 10% to 22%, the air decay performance of the sealed joint not only meets the now required automotive standard, but greatly exceeds it (i.e., is substantially less than the 0.1 cm³/min standard).

Consequently, the empirical data (both numerically and graphically represented) shows that the configuration of the new construction element 100 provides a much greater sealing capability than conventional construction elements. Indeed, this advantage is a direct correlation of the reduction in the (maximum) lug-width to (maximum) punch portion width ratio. Not only does this new design provide improved performance, but it also meets, and greatly exceeds, a now recognized industrial standard.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. A self-clinching construction element for attachment to a plastically deformable metal substrate, the self-clinching construction element comprising:
a body portion with a central axis, the body portion including an annular-shaped surface extending in a direction perpendicular to the central axis;
a punch portion being coaxial with the central axis and extending from the body portion such that the annular-shaped surface encircles the punch portion, the punch portion including an outer peripheral surface extending in a direction of the central axis; and
a plurality of spaced apart lugs axially projecting outwards from the annular-shaped surface and extending radially outwards from the outer peripheral surface of the punch portion, the plurality of spaced apart lugs collectively encircling the punch portion,
wherein a lug of the plurality of spaced apart lugs has a maximum width that is less than a maximum width of the punch portion, and wherein a percentage ratio between the maximum width of the lug and the maximum width of the punch portion is in a range of 10% to 22%.

2. The self-clinching construction element of claim 1, wherein the outer peripheral surface of the punch portion has a cylindrical profile, and wherein the maximum width of the punch portion is a maximum diameter of the cylindrical profile.

3. The self-clinching construction element of claim 1, wherein the lug has opposite, first and second end portions, wherein the first end portion is disposed adjacent to the outer peripheral surface of the punch portion, and wherein the second end portion extends away from the first end portion in the direction perpendicular to the central axis.

4. The self-clinching construction element of claim 3, wherein a width of the lug varies between the first and second end portions thereof.

5. The self-clinching construction element of claim 4, wherein the width of the lug continuously increases with distance from the outer peripheral surface of the punch portion.

6. The self-clinching construction element of claim 3, wherein the body portion includes an outer peripheral surface extending in the direction of the central axis, wherein the annular-shaped surface of the body portion terminates at a peripheral edge which is coterminous with the outer peripheral surface of the body portion, and wherein the second end portion of the lug is provided at the peripheral edge.

7. The self-clinching construction element of claim 6, wherein the maximum width of the lug is taken at the second end portion of the lug.

8. The self-clinching construction element of claim 1, wherein the annular-shaped surface has opposite, first and second end portions, wherein the first end portion is provided adjacent the outer peripheral surface of the punch portion, and wherein the annular-shaped surface is angled with respect to an imaginary horizontal plane.

9. The self-clinching construction element of claim 8, wherein the imaginary horizontal plane is coterminous with the first end portion of the annular-shaped surface, and wherein the annular-shaped surface is inclined with respect to the imaginary horizontal plane such that a distance between the annular-shaped surface and the imaginary horizontal plane continuously increases with distance from the outer peripheral surface of the punch portion.

10. The self-clinching construction element of claim 9, wherein the lug has opposite, first and second end portions, wherein the first end portion of the lug is disposed adjacent to the outer peripheral surface of the punch portion, and wherein a contact face of the lug is inclined with respect to the imaginary horizontal plane such that a distance between the contact face and the imaginary horizontal plane continuously increases with distance from the outer peripheral surface of the punch portion.

11. The self-clinching construction element of claim 10, wherein a first axial distance between the second end portion of the lug and a distal end of the punch portion is less than a second axial distance between the second end portion of the annular-shaped surface and the distal end of the punch portion, and wherein a percentage ratio between the first and second axial distances is less than or equal to 50%.

12. The self-clinching construction element of claim 1, wherein a first minimum axial distance between the lug and a distal end of the punch portion is less than a second minimum axial distance between the annular-shaped surface and the distal end, and wherein a percentage ratio between the first and second minimum axial distances is less than or equal to 50%.

13. The self-clinching construction element of claim 1, wherein the outer peripheral surface of the punch portion has a cylindrical profile, and the outer peripheral surface of the punch portion comprises:
a plurality of spaced apart cutouts encircling the punch portion;
a plurality of spaced apart column portions encircling the punch portion, wherein each of the column portions is disposed between and spaces apart a respective pair of adjacently spaced apart cutouts; and
a plurality of bridge portions encircling the punch portion, wherein each bridge portion connects a respective pair of adjacently spaced apart column portions,
wherein each of the column portions and each of the bridge portions has the cylindrical profile, and wherein each of the column portions and each of the bridge portions resides on a common, imaginary circumferential plane.

14. The self-clinching construction element of claim 13, wherein each column portion extends from the annular-shaped surface of the body portion to a distal peripheral edge of the outer peripheral surface of the punch portion.

15. The self-clinching construction element of claim 14, wherein each bridge portion is positioned axially between the distal peripheral edge of the outer peripheral surface of the punch portion and a respective cutout of the plurality of cutouts.

16. The self-clinching construction element of claim 13, wherein each lug of the plurality of spaced apart lugs is radially aligned with a respective one of the plurality of spaced apart cutouts.

17. The self-clinching construction element of claim 1, wherein the outer peripheral surface of the punch portion has a cylindrical profile, wherein the maximum width of the punch portion is a maximum diameter of the cylindrical profile,
wherein a first minimum axial distance between the lug and a distal end of the punch portion is less than a second minimum axial distance between the annular-shaped surface and the distal end, and wherein a percentage ratio between the first and second minimum axial distances is less than or equal to 50%.

18. A self-clinching construction element for attachment to a plastically deformable metal substrate, the self-clinching construction element comprising:
a body portion with a central axis, the body portion including an annular-shaped surface extending in a direction perpendicular to the central axis and an outer peripheral surface extending in a direction of the central axis;
a punch portion being coaxial with the central axis and extending from the body portion such that the annular-shaped surface encircles the punch portion, the punch portion including an outer peripheral surface extending in the direction of the central axis and having a cylindrical profile; and
a plurality of spaced apart lugs axially projecting outwards from the annular-shaped surface and extending radially outwards from the outer peripheral surface of the punch portion, the plurality of spaced apart lugs collectively encircling the punch portion,
wherein a lug of the plurality of spaced apart lugs has a maximum width that is smaller than a maximum diameter of the punch portion, and wherein a percentage ratio between the maximum width of the lug and the maximum diameter of the punch portion is in a range of 10% to 22%,
wherein the annular-shaped surface of the body portion terminates at a peripheral edge which is coterminous with the outer peripheral surface of the body portion,
wherein the lug has opposite, first and second end portions, wherein the first end portion is disposed adjacent to the outer peripheral surface of the punch portion, and wherein the second end portion is provided at the peripheral edge,
wherein a width of the lug increases with distance from the outer peripheral surface of the punch portion, and wherein the maximum width of the lug is taken at the second end portion.

19. The self-clinching construction element of claim 18, wherein the outer peripheral surface of the punch portion comprises:
a plurality of spaced apart cutouts encircling the punch portion;
a plurality of spaced apart column portions encircling the punch portion, wherein each of the column portions is disposed between and spaces apart a respective pair of adjacently spaced apart cutouts; and
a plurality of bridge portions encircling the punch portion, wherein each bridge portion connects a respective pair of adjacently spaced apart column portions,
wherein each of the column portions and each of the bridge portions has the cylindrical profile, and wherein each of the column portions and each of the bridge portions resides on a common, imaginary circumferential plane,
wherein each lug of the plurality of spaced apart lugs is radially aligned with a respective one of the plurality of spaced apart cutouts.

20. The self-clinching construction element of claim 19, wherein a first minimum axial distance between the lug and a distal end of the punch portion is less than a second minimum axial distance between the annular-shaped surface and the distal end, and wherein a percentage ratio between the first and second minimum axial distances is less than or equal to 50%.
